(19) United States
(12) Patent Application Publication
(10) Pub. No.: US 2026/0000568 A1
(43) Pub. Date: Jan. 1, 2026

(54) Multi-Corner Massager

(71) Applicant: Jiangsu Laiao Material Technology Co., Ltd, Jiangsu (CN)

(72) Inventor: Xinlong ZHU, Jiangsu (CN)

(73) Assignee: Jiangsu Laiao Material Technology Co., Ltd, Jiangsu (CN)

(21) Appl. No.: 18/800,008

(22) Filed: Aug. 10, 2024

(30) Foreign Application Priority Data
Jun. 27, 2024 (CN) 202410847918.3

(51) Int. Cl. A61H 7/00

(52) U.S. Cl. CPC A61H 7/005; A61H 2201/1685; A61H 2201/1695

(57) ABSTRACT

A multi-corner massager comprises a main body, wherein the main body is composed of a plurality of support surfaces used for contacting a support and supporting the main body, the support surfaces are connected in pairs to form a polygonal pyramid structure, and the joint between two adjacent support surfaces is formed into an arc-shaped massage edge; each vertex of the polygonal pyramid structure is set as a massage part protruding outward, and all massage parts have different shapes and sizes.

### CROSS-REFERENCE TO RELATED APPLICATIONS

This application claims the priority of China Patent Application No. 202410847918.3 filed on Jun. 27, 2024, entitled “Multi-corner Massager”, all the contents and amendment of which are incorporated into this application by reference.

### TECHNICAL FIELD

The present invention relates to the technical field of massagers, in particular to a multi-corner massager.

### BACKGROUND

Manual massager is a kind of massage equipment that can be operated manually, which is mainly used to relieve physical fatigue and muscle soreness. This kind of massager is usually simple and easy to operate, and it is easy to carry, so it is a good helper for modern people to relax fatigue daily.

Manual massagers provide different degrees of pressure through massage heads of different sizes and shapes. Moderate pressure can promote blood circulation and relieve muscle tension and pain. However, at present, the massage heads of some manual massagers are roughly the same in size and shape, and because different people have different needs and preferences, for example, some people like strong stimulation, while others prefer gentle massage, so if the massage heads are all the same, users cannot choose the massage heads they need according to their needs.

For example, a Chinese utility model with a publication number of CN201537223U discloses a manual foot acupoint massager, wherein the massage heads of the patent are all of the same size and shape, and at the same time, when the patent is used, if the massage part needs great stimulation, the demand for hand strength is very large, which makes it very easy to get tired.

Therefore, there is a need to put forward a new type of massager, which can have multiple massage heads with different sizes and shapes, thus being convenient for different people. Moreover, the new massager is more convenient and labor-saving to use when it needs great massage stimulation.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a multi-corner massager to solve the problems that the massage heads of the massagers in the prior art mentioned in the background art are the same, different massage heads cannot be selected as required, and manual massage requires great effort and may easily cause fatigue.

In order to achieve the above object, the present invention adopts the following technical solution:
the present invention provides a multi-corner massager, which includes a main body; the main body is composed of a plurality of support surfaces, which are used for contacting a support and supporting the main body; the plurality of support surfaces are connected in pairs to form a polygonal pyramid structure, and a massage edge is formed at a joint between two adjacent support surfaces; and
each vertex of the polygonal pyramid structure is set as a massage part protruding outwards, and all massage parts have different shapes and sizes.

The present invention further provides a multi-corner massager, which includes a main body; the main body is composed of a plurality of support surfaces, which are used for contacting a support and supporting the main body; the plurality of support surfaces are connected in pairs to form a polygonal pyramid structure, and a massage edge is formed at a joint between two adjacent support surfaces; and
each vertex of the polygonal pyramid structure is set as a massage part protruding outwards, all massage parts have different shapes and sizes, and the tops of the massage parts are set as contact parts for contacting a human body.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the present invention.

FIG. 2 is a schematic structural view of the right view of FIG. 1.

FIG. 3 is a schematic structural view of the top view of FIG. 2 according to the present invention.

FIG. 4 is a schematic structural view of another embodiment of the contact part of the present invention.

FIG. 5 is a schematic diagram of the plane structure of the present invention.

Reference signs: Main body (1); Support surface (101); Massage edge (102); Massage part (2); First massage head (201); Second massage head (202); Third massage head (203); Fourth massage head (204); Contact part (205); Protrusion (206).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

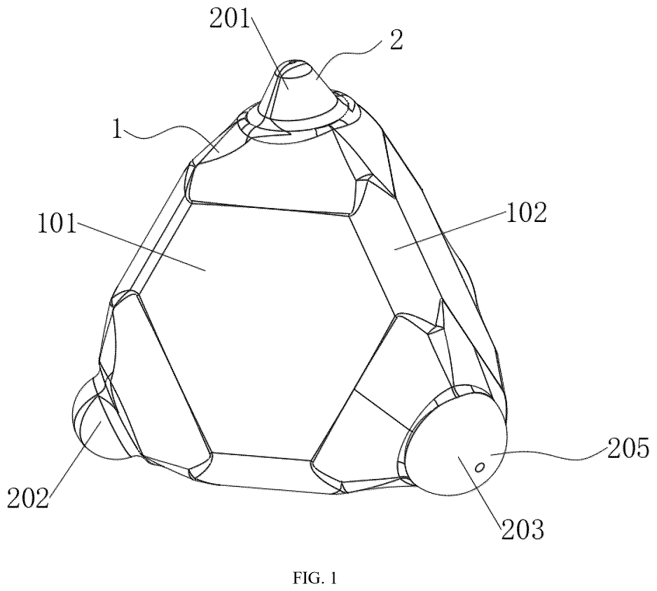

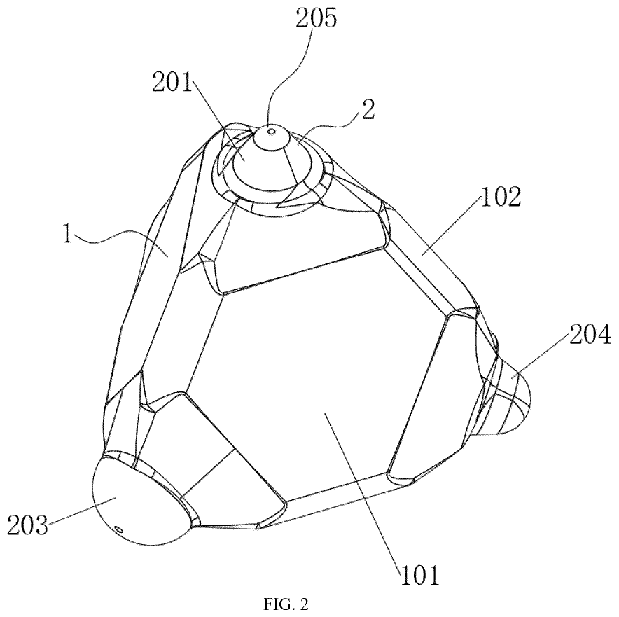

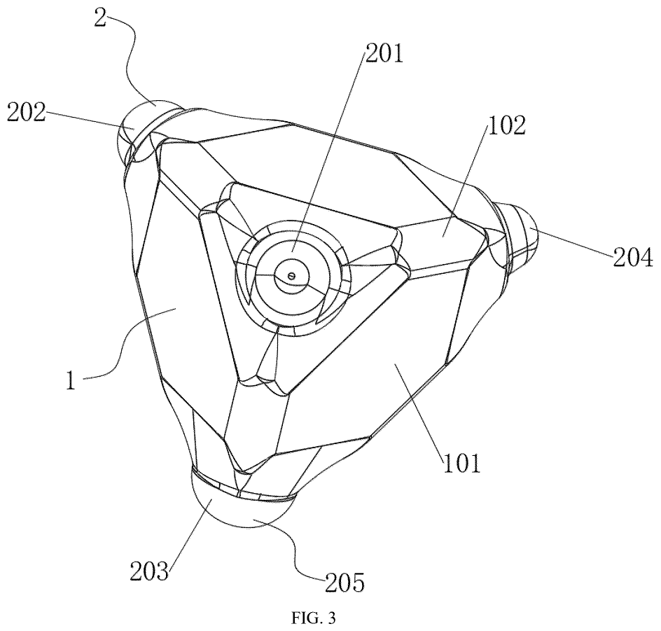

Please refer to FIG. 1 to FIG. 3:
the present invention provides a multi-corner massager, which includes a main body 1, wherein the main body 1 is composed of a plurality of support surfaces 101, and the support surfaces 101 are used for contacting a support and supporting the main body 1; the plurality of support surfaces 101 are connected in pairs to form a polygonal pyramid structure; the joint between two adjacent support surfaces 101 is formed into an arc-shaped massage edge 102; each vertex of the polygonal pyramid structure is set as a massage part 2 protruding outwards; and all massage parts 2 have different shapes and sizes.

In this embodiment, the polygonal pyramid structure is in the shape of a regular triangular pyramid, and by adopting the regular triangular pyramid structure, each support surface 101 has a massage part 2 at its opposite vertex. When the support surface 101 is placed on a support object, the placement stability of the massager can be improved, and it is also convenient to use the massage part 2.

In other embodiments (not shown), other polygonal structures can also be selected as the shape of the massager, such as quadrangular pyramid, pentagonal pyramid and other polygonal pyramid shapes, which can optimize the massage experience and function.

For example, when the massager takes the shape of a rectangular pyramid, because the rectangular pyramid has four equal-length sides and a bottom surface, and the bottom surface is a rectangular pyramid, such as a square or a rectangle, this shape makes the area of the support surface 101 larger and the massager more stable when placed; moreover, similar to the regular triangular pyramid, a massage part 2 can be arranged at the vertex of the opposite end of each side to meet different massage needs.

When the massager takes the shape of a pentagonal pyramid, a hexagonal pyramid, a heptagonal pyramid, etc., its principle is similar to that of a quadrangular pyramid, except that there are more vertices and support surfaces 101 in other polygonal pyramid structures, so that more massage parts 2 can be provided.

The materials of the main body 1 and the massage part 2 include but are not limited to EPP material, silica gel material or ABS plastic material, in which silica gel has good softness, elasticity and durability, and it also has certain anti-skid performance, which makes the massage process more comfortable and safer. Silica gel is also easy to clean and disinfect, and is suitable for occasions with high personal hygiene requirements.

In this embodiment, one massage part 2 is a first massage head 201, and the waist line of the first massage head 201 is an inclined surface; one massage part 2 is a second massage head 202, and the waist line of the second massage head 202 is a curved surface; one massage part 2 is a third massage head 203, and the waist line of the third massage head 203 is a curved surface with a curvature smaller than that of the second massage head 202; one massage part 2 is a fourth massage head 204, and the waist line of the fourth massage head 204 is an inclined surface with a slope greater than that of the first massage head 201; and the tops of the massage parts 2 are all set as contact parts 205 for contacting a human body.

When using a massager with a polygonal pyramid structure, grasp the main body 1 and massage the part to be massaged through the massage part 2. When the massage part 2 is in contact with the human body and is pressed, it will produce stimulation and massage effects, which is helpful to relieve muscle tension, promote blood circulation and relieve stress.

By designing the waist line of the massage part 2 into various shapes, the area of the contact part 205 formed at the top of each massage part 2 is changed. This design brings more functional and personalized experiences to the massager. The contact part 205 with different sizes will generate different pressures during massage, thus generating different degrees of stimulation, so that users can choose the appropriate massage part 2 according to their own needs.

Specifically, the massage part 2 with a small contact part 205 has a large pressure during massage, which is suitable for users who need deep stimulation and intense relaxation. The massage part 2 with larger contact parts 205 has lower pressure, which is more suitable for users who need gentle massage and relieve pressure. This design makes the massager more flexible and can meet the massage needs of different users in different situations.

In this embodiment, the contact part 205 is in a relatively smooth arc shape, and the applicability and user experience of the massager can be improved through the smooth contact part 205;
for example, the smooth cambered contact part 205 can better fit the human body curve, and a suitable massage part can be found regardless of the user's body shape, which makes the massager suitable for the needs of most users; at the same time, the curved contact part 205 can reduce the friction with the skin during massage, providing a more comfortable massage experience, especially for users with sensitive skin, which can effectively reduce discomfort and irritation; moreover, the curved contact part 205 can evenly distribute pressure during massage, avoiding pain or discomfort caused by excessive local pressure. At the same time, the curved shape can better fit the muscles, which is helpful to relax the muscles and relieve fatigue; moreover, the smooth contact part 205 is easier to clean and maintain, reducing the risk of bacterial growth and cross infection, which is of great significance for maintaining the hygiene of the massager and prolonging the service life.

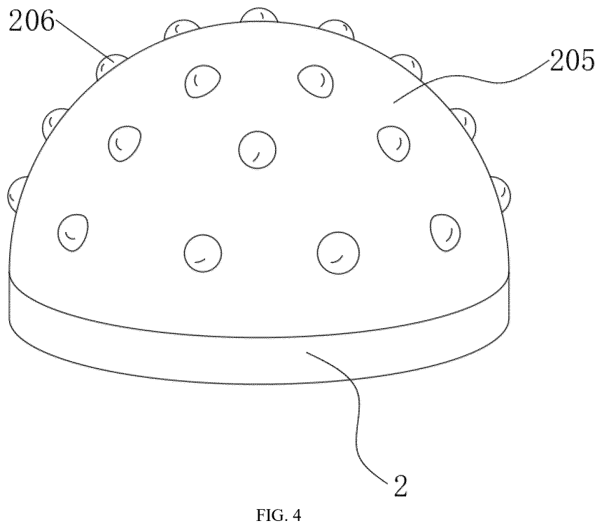

In other embodiments, as shown in FIG. 4, the surface of the contact part 205 is provided with a plurality of protrusions 206. By arranging the protrusions 206, the stimulation intensity of the massager can be further improved, and a stronger massage experience can be provided for those users with strong stimulation tolerance, for example:
the protrusions 206 can increase the contact points between the contact part 205 and the skin, thereby generating more stimulation points during massage, and these protrusions 206 will generate extra pressure on the human body during massage, thereby enhancing the stimulation effect of massage;

By arranging the protrusions 206 with different shapes, sizes and distribution densities, the massager can provide more diversified massage stimuli, and users can choose the appropriate protrusions 206 according to their own needs and bearing capacity to obtain the most satisfactory massage effect;

The protrusion 206 can also stimulate blood vessels and nerve endings under the skin more effectively during massage, and promote local blood circulation and metabolism, which is helpful to relieve muscle fatigue and improve the body's resistance, which is especially important for some users who need deep relaxation and recovery.

Finally, the contact part 205 is not limited to the above two embodiments. In other embodiments, the contact part 205 can be any other shape or structure suitable for stimulating human body parts:
for example, the contact part 205 is set as fine grooves, ripples, etc. (not shown), and these textures can increase the friction during massage, thus providing a more unique massage feeling; it can also be set as wavy, S-shaped or other curved shapes (not shown), which can better fit the curve of human body, increase the comfort during massage and produce different massage effects.

In other embodiments (not shown), a soft material (such as silica gel and memory sponge) can also be wrapped on the outer layer of the contact part 205. Therefore, in the process of massage, this layer of soft material (such as silica gel) can be attached to the massage part more naturally, which increases the softness and comfort of the massager and reduces the irritation and discomfort to the skin.

By arranging the massage edge 102, the massager not only has the traditional massage function, but also can massage in the form of face, which can greatly improve the applicability and practicability of the massager.

For example, through the design of the massage edge 102, the massager can cover a wider area when massaging, and is especially suitable for massaging large areas such as face and back. Compared with the traditional point or line massage, the massage in the form of a surface can better fit the human body curve and provide a more comprehensive and uniform massage effect.

For facial massage, the massage edge 102 can gently stimulate facial skin, promote blood circulation, and help to relieve facial fatigue. At the same time, the massage method with a surface can also reduce the pressure on facial skin, making the massage process more comfortable.

Among them, for back massage, the design of massage edge 102 can go deep into muscle tissue, effectively relieve back pain and stiffness, and at the same time, it can cover a wider back area by face massage, making the massage effect more comprehensive and deeper.

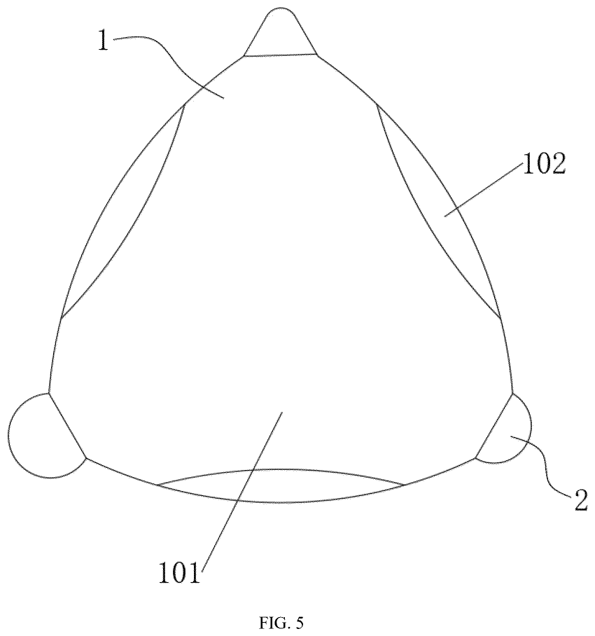

In other embodiments of the massage edge 102, as shown in FIG. 5, the middle part of the massage edge 102 is arched away from the main body 1. By this structure, the middle part of the massage edge 102 is arched, so that it can contact and stimulate the skin or muscle tissue more deeply during massage. This locally enhanced stimulation is helpful to relax tight muscles and relieve local pain or discomfort.

However, for different users with different needs and feelings for massage stimulation, each massage edge 102 can be arranged in a structure with different arching ranges, so that massage stimulation with different intensities can be provided for users to meet individual needs.

By arranging the support surface 101 on the massager, great convenience is provided for the user in the process of massage. When it is necessary to exert great force to stimulate the massage part 2, the user can attach the massager to the surface of a support such as a wall, a floor or a desktop through the support surface 101, so that when the user massages, the user only needs to exert force on the part to be massaged, and the massager is used as the stressed party, so that the massager does not need to be pushed by hands to massage. In this way, users do not need to exert strength with their hands continuously, thus greatly reducing the possibility of hand fatigue. At the same time, this way also makes the massage process more labor-saving, and users can enjoy the comfort brought by massage more easily.

In other embodiments (not shown), a rubber sucker can be installed on the support surface 101, and the sucker can be adsorbed on a smooth surface, thus greatly enhancing the fixing ability of the massager on the smooth surface; therefore, in this way, the massager can be stably adsorbed on smooth surfaces such as glass and ceramic tiles, so as to provide more stable and safe support during massage.

In other embodiments (not shown), the support surface 101 of the main body 1 can also be provided with smooth bumps, which can increase the contact area between the user's hand and the massager main body, thus improving the friction. When grasping the massager for massage operation, the user can have a more stable grip feeling without slipping off, and the comfort and stability of hands can be kept even if it is used for a long time. In addition, when the massager is held by hand and massaged by the massage part 2, the bumps can also play the role of hand massage, thus realizing double-layer massage. Of course, the support surface 101 with bumps can also be directly used to massage human body parts, which has a large massage area and is soft and comfortable.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A multi-corner massager comprising a main body, wherein,
the main body is composed of a plurality of support surfaces, which are used for contacting a support and supporting the main body; the plurality of support surfaces are connected in pairs to form a polygonal pyramid structure, and a massage edge is formed at a joint between two adjacent support surfaces; and
each vertex of the polygonal pyramid structure is set as a massage part protruding outwards, and all massage parts have different shapes and sizes.

2. The multi-corner massager according to claim 1, wherein one of the massage parts is a first massage head, and a waist line of the first massage head is an inclined surface.

3. The multi-corner massager according to claim 1, wherein one of the massage parts is a second massage head, and a waist line of the second massage head is a curved surface.

4. The multi-corner massager according to claim 3, wherein one of the massage parts is a third massage head, and a waist line of the third massage head is a curved surface with a curvature smaller than that of the second massage head.

5. The multi-corner massager according to claim 2, wherein one of the massage parts is a fourth massage head, and a waist line of the fourth massage head is an inclined surface with a slope greater than that of the first massage head.

6. The multi-corner massager according to claim 1, wherein the tops of the massage parts are all set as contact parts for contacting a human body.

7. The multi-corner massager according to claim 6, wherein each of the contact part is a relatively smooth cambered surface.

8. The multi-corner massager according to claim 6, wherein a surface of the contact part is provided with a plurality of protrusions.

9. The multi-corner massager according to claim 1, wherein a middle part of the massage edge is arched away from the main body.

10. A multi-corner massager comprising a main body, wherein,
the main body is composed of a plurality of support surfaces, which are used for contacting a support and supporting the main body; the plurality of support surfaces are connected in pairs to form a polygonal pyramid structure, and a massage edge is formed at a joint between two adjacent support surfaces; and
each vertex of the polygonal pyramid structure is set as a massage part protruding outwards, all massage parts have different shapes and sizes, and the tops of the massage parts are set as contact parts for contacting a human body.

11. The multi-corner massager according to claim 10, wherein the contact part is a relatively smooth cambered surface.

12. The multi-corner massager according to claim 10, wherein a surface of the contact part is provided with a plurality of protrusions.

13. The multi-corner massager according to claim 10, wherein the contact part is provided with a groove or ripple with a fine surface.

14. The multi-corner massager according to claim 10, wherein the contact part is wavy or S-shaped.

15. The multi-corner massager according to claim 10, wherein the massage edge is linear.

16. The multi-corner massager according to claim 10, wherein a middle part of the massage edge is arched away from the main body and forms an arc.

17. The multi-corner massager according to claim 16, wherein the plurality of massage edges have different arching radians.
